(19) United States
(12) Patent Application Publication
(10) Pub. No.: US 2004/0177552 A1
(43) Pub. Date: Sep. 16, 2004

(54) Lawn edging abutting hard surface pathways

(76) Inventor: Mark William Lewis, Bloomfield Hills, MI (US)

Correspondence Address: MARK W. LEWIS, 3550 RAYBURN, BLOOMFIELD HILLS, MI, 48304, US

(21) Appl. No.: 10/384,851

(22) Filed: Mar. 11, 2003

(51) Int. Cl. A01G 1/00

(52) U.S. Cl. 47/33

(57) ABSTRACT

An extruded plastic lawn edging consisting of a flat surface edge of 1.0 inches or less in width for the purpose of providing a fresh edged appearance along hard surface pathways by preventing vegetation growth. It is symmetrical, consisting of a flat base abutting a hard surface pathway, a surface edge of 1.0 inches or less, and a soil anchoring edge of the same width. The symmetry promotes low cost and flexibility in manufacturing, coiling, packaging, shipping, storing, displaying, and installing.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

This invention's primary application is the separation of grasses and vegetation from hard surface pathways, walkways, driveways, curbs, or other hard surfaces where a bladed edging tool would be used. The invention when installed gives the appearance similar to that obtained when an edging tool is used to clear the soil between pathways and grasses, resulting in a small yet clean and attractive separation.

The relevant prior arts primary applications for extruded plastic edging are either: 1. The separation of lawns from garden beds, with round and/or decorative top edges, or 2: the separation of lawns from foundations or other raised structures using an “L” shape with larger vegetation barriers.

Representative lawn edgings of the first type include:

U.S. Pat. No. 3,788,001 issued on Jan. 29, 1974 to G. F. Balfanz, Jr.

U.S. Pat. No. 5,456,045 issued on Oct. 10, 1995 to D. R. Bradley et al.

U.S. Pat. No. 5,715,628 issued on Feb. 10, 1998 to T. Beladakis

U.S. Pat. No. 6,108,969 issued on Aug. 29, 2000 to Danna et al.

U.S. Pat. No. 6,138,405 issued on Oct. 31, 2000 to Matz M. W.

U.S. Pat. No. 6,226,934 issued on May 8, 2001 to J. N. Gaston

U.S. Pat. No. 6,253,486 issued on Jul. 3, 2001 to Prassar et al.

U.S. Pat. No. 6,293,046 issued on Sep. 25, 2001 to Meglino et al.

Representative lawn edgings of the second type include:

U.S. Pat. No. 4,809,459 issued on Mar. 7, 1989 to Brylla et al.

U.S. Pat. No. 5,857,288 issued on Jan. 12, 1999 to W. V. Wiste

U.S. Pat. No. 6,336,290 issued on Jan. 8, 2002 to T. P. Callan

U.S. Pat. No. 6,385,898 issued on May 14, 2002 to R. E. Noel.

This invention's embodiment is specifically the small but attractive separation similar to that created when an edging tool is used to remove the vegetation adjacent to hard surface pathways, walkways, driveways, curbs, or other hard surfaces abutting grasses and vegetation at approximately the same horizontal surface height.

The current invention's application also addresses the need addressed in the prior art for an approach lending itself to easy coiling for packaging, shipping, storing and display racking in a convenient stable form. This is accomplished by using a symmetrical shape consisting of a base and two identical tabs canted at 45 degree angles towards the center. The tabs flexibility allow the product to be installed with either tab in the up or down position, and to be conveniently rolled for packaging.

### SUMMARY OF THE INVENTION

The invention is a plastic extruded edging product to be primarily installed between hard surface pathways and grasses or vegetation. Installed, it gives the appearance similar to that achieved with an edging tool; an attractive yet small separation between hard surfaces and grasses. It is symmetrical in shape, and can be installed with either side up, lending itself to simple manufacture, low cost to consumers, and ease of installation. Its flexible tabs allow for easy coiling for packaging, shipping, storing, and display racking.

### BRIEF DESCRIPTION OF THE DRAWINGS

FIG. 1 illustrates the installation between a hard surface pathway and grass 1.

FIG. 2 shows an end view on the left as installed. The base 2 has tabs 3a and 3b attached at the base ends 4. The end view on the right is the invention as manufactured, with the ability of either tab to flex to 90 degrees as shown by the arrows 5.

FIG. 3 shows the product coiled for packaging and shipping.

### DETAILED DESCRIPTION OF THE INVENTION

While this invention could be embodied in many variations and forms, its strength is its simplicity and low cost for production, shipment, and installation. This products simplistic design and small profile will make it available at a price point affordable to most consumers. The primary application is to provide that “fresh edged” look, similar to that produced by an edging tool, along hard surface pathways in contact with grasses.

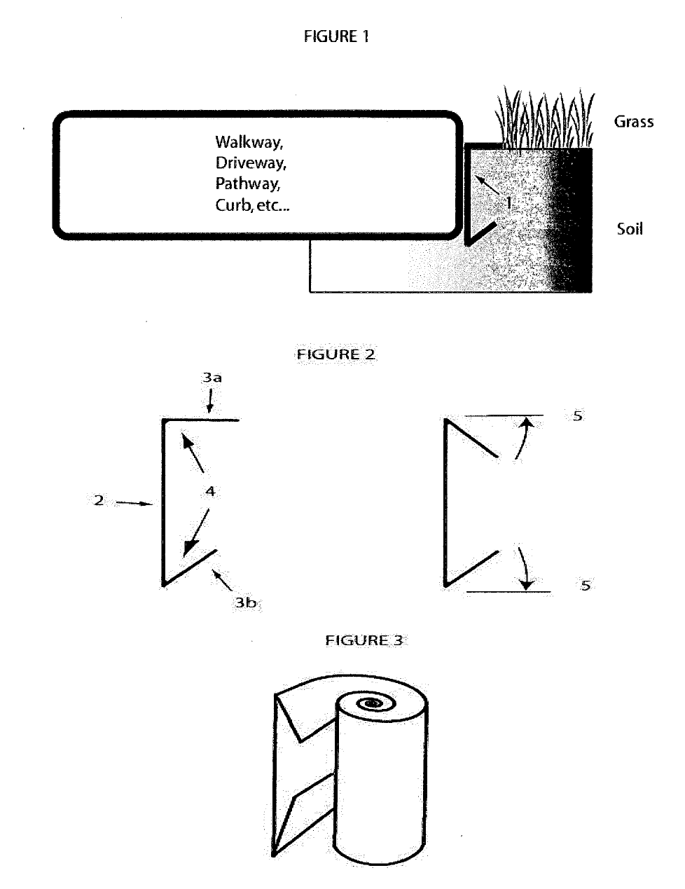

Beginning with FIG. 1, the edging 1 can be installed with either tab up or down, making installation simple. The product maintains a low profile, at ground level, providing a small, typically 1.0 inches or less, but distinct edge between the grass and hard surface. This ground level installation adjacent to the hard surface, keeps the product from being damaged by lawn mowers, weed-whackers, and other lawn maintenance products.

Some flexibility exists to adjust the width of the gap maintained between the pathway and vegetation, by allowing the upper tab to have a slight slope away from the pathway towards the vegetation. This embodiment would be achieved by installing the edging as manufactured (FIG. 2 on the right). This slight slope would also promote water run-off and keep debris from covering the edging product to a depth where vegetation could take root and sprout.

The grass will also lean slightly over the edging product after installation, which will keep the gap from being too wide and result in a natural edged appearance.

Normal grass clippings, leaves, and debris will cover the edging products surface, over a few weeks, resulting in a natural appearance. The “fresh edged” appearance will exist, without the plastic surface being evident. This is also an aid to low cost production as only a small portion of the surface, if any, will be visible. This allows for higher production volume as tolerances and esthetics are not as critical. The plastic barrier will prevent vegetation from growing up from underneath. The ground level installation should prevent sufficient depth of debris to not allow vegetation to grow on top of the edging product.

FIG. 2 shows the product as installed on the left, and as manufactured on the right. The base 2 of the product is flat to remain close to the hard surface pathway, and of sufficient length to prevent the product from pulling out of the ground.

The tabs 3a and 3b are attached to the base 2 at the ends 4. They can flex to 90°'s as depicted by the arrows at 5, from their manufactured 45° angle of attachment to the base as shown in the right hand illustration of FIG. 2 at 5. This provides many advantages: symmetrical tabs for installation from either side up; the ability to flex around ground obstructions during installation, such as rocks; some ability to adjust the width of the gap between grasses and the hard surface walkway; and, the ability to coil the product easily for symmetrical packaging.

The tabs 3a and 3b have sufficient size to fill with soil upon installation and provide adequate resistance to keep the base from rising. Their flexibility also aids in making it more difficult to pull the product from the ground, as the product will give and spring back rather than staying rigid and pulling out.

The tabs 3a and 3b are attached to the ends of the base 2 at 4. Where these tabs attach 4 they are reinforced with additional material in a fillet, to prevent the tabs from tearing from the base and assisting in maintaining the 45° production angle for coiling and shipping.

FIG. 3 illustrates the product as coiled for packaging and shipping. The thin tabs and flat part base profile combine to provide low cost production, packaging, shipping, storing and displaying. This will result in a lower cost option to appeal to a wide range of consumers. The product should be as affordable for residences as commercial establishments.

I claim:

1. A lawn edging installed at the soil surface between hard surface pathways and grasses comprising of:
a flat surface edge of 1.0 inches or less in width for preventing vegetation growth and providing an appearance similar to that obtained by a bladed edging tool.
a symmetrical soil anchoring edge of the same dimension as the surface edge, to keep the edging in the soil.
a soil-penetrating base for attaching the edges
a flat-flexible base to follow the hard surface pathway as closely as possible to prevent vegetation growth and permit flexing along curves.
symmetrical edges attached to the ends of the base at 45° angles to promote flexibility, low cost in manufacturing, coiling for packaging, shipping, storing, and ease of installation.

2. The flat surface edge as claimed in claim 1, may rest on the soil surface or be installed at an angle sloping away from the hard surface towards the lawn or vegetation to provide flexibility for a narrow or wider edged appearance, and facilitate debris and water run-off from the hard surface onto the vegetation.

3. Either edge claimed in claim 1, may be installed in the up or surface position.

4. The edges as claimed in claim 1, have fillet material on the inside edges where they attach to the base to provide strength, prevent tearing, and maintain an inward angle for ease of coiling.
